(19) United States
(12) Patent Application Publication
(10) Pub. No.: US 2010/0106407 A1
(43) Pub. Date: Apr. 29, 2010

(54) NAVIGATION SYSTEM

(76) Inventors: Wataru Yamazaki, Tokyo (JP); Fumitaka Sato, Tokyo (JP); Atsushi Kohno, Tokyo (JP); Yuta Kawana, Tokyo (JP); Osamu Gojo, Tokyo (JP)

Correspondence Address: BIRCH STEWART KOLASCH & BIRCH, PO BOX 747, FALLS CHURCH, VA, 22040-0747, US

(21) Appl. No.: 12/596,285

(22) PCT Filed: Apr. 17, 2008
(86) PCT No.: PCT/JP2008/001015

§ 371 Date: Oct. 16, 2009

(30) Foreign Application Priority Data
Jun. 11, 2007 (JP) 2007-154224

(51) Int. Cl. G01C 21/00

(52) U.S. Cl. 701/207; 701/200

(57) ABSTRACT

A navigation system has: a candidate input device 14 for inputting a search key; an input vocabulary storage 11 that stores words to become candidates of a search key input from the candidate input device; a vehicle information storage 12 for storing vehicle information relating to a vehicle; a preference information storage 13 for storing preference information representing user' preference in connection with the words stored in the input vocabulary storage; an input word estimating module 17 for searching the input vocabulary storage for words corresponding to the search key input from the candidate input device, and for estimating the words obtained by the search in accordance with an order of priority based on the vehicle information read out of the vehicle condition storage and the preference information read out of the preference information storage; and a candidate output device 15 for outputting the words delivered from the input word estimating module as candidates.

### TECHNICAL FIELD

The present invention relates to a navigation system for guiding a user to a prescribed position, and more particularly to a technique for inputting the prescribed position.

### BACKGROUND ART

Recently, car navigation systems have come into widespread use. On a car navigation system, although a user can input a character string representing a destination or a way point with a remote control or a keyboard on a touch panel, it has a problem in that the input of the character string is troublesome.

To reduce the troublesomeness of inputting the character string, Patent Document 1 discloses an input support device that inputs information by using information about surroundings. In the input support device, a surrounding information acquiring module obtains information about surroundings of the input support device. For example, it obtains surrounding information such as information obtained by a sensor like a temperature sensor or information transmitted from neighboring information equipment. According to the surrounding information the surrounding information acquiring module obtains, a candidate character string acquiring module obtains candidate character strings from a character string information storage that stores character string information containing character strings that can be input. The configuration makes it possible to input the information efficiently and appropriately.

In addition, Patent Document 2 discloses a navigation system that can set a route by providing each user with a destination satisfying his or her preference or suitability. To reflect the preference of the user in making a decision of a way point after inputting the final destination, the navigation system retains the attribute information associated with a spot as a table, calculates frequency of the attribute information, and displays a destination candidate list reflecting the preference of the user when the user inputs the date and time or a destination area by manipulating an operation module.

Patent Document 1: Japanese Patent Laid-Open No. 2005-107749.

Patent Document 2: Japanese Patent Laid-Open No. 2004-309368.

However, the technique disclosed in the foregoing Patent Document 1 estimates the input character string only according to the frequency of the input character string and to the information obtained from the sensor. Accordingly, the preference of the user is not reflected in the estimated character string, and thus it offers a problem in that the probability of obtaining the desired character string is low.

In addition, the technique disclosed in Patent Document 2 is configured in such a manner that the preference is reflected in a way point on the basis of the input of the final destination. Accordingly, it cannot estimate the destination, and hence the user must enter data for obtaining the destination list. Consequently, the troublesomeness of the character input is left.

The present invention is implemented to solve the foregoing problems. Therefore it is an object of the present invention to provide a navigation system capable of reducing the troublesomeness at the time of inputting a destination.

### DISCLOSURE OF THE INVENTION

To solve the foregoing problems, a navigation system in accordance with the present invention includes: a candidate input device for inputting a search key; an input vocabulary storage that stores words to become candidates of a search key input from the candidate input device; a vehicle condition storage for storing vehicle information relating to a vehicle; a preference information storage for storing preference information representing user's preference in connection with the words stored in the input vocabulary storage; an input word estimating module for searching the input vocabulary storage for words corresponding to the search key input from the candidate input device, and for estimating the words obtained by the search in accordance with an order of priority based on the vehicle information read out of the vehicle condition storage and the preference information read out of the preference information storage; and a candidate output device for outputting the words delivered from the input word estimating module as candidates.

According to the navigation system in accordance with the present invention, since it is configured in such a manner as to search the input vocabulary storage for words corresponding to the search key, to estimate the words obtained by the search in accordance with the order of priority based on the vehicle information and preference information, and to output them, the candidates of the words corresponding to the user's preference are output. Accordingly, it can reduce troublesomeness at the time of inputting a destination.

### BRIEF DESCRIPTION OF THE DRAWINGS

FIG. 1 is a block diagram showing a configuration of a navigation system of an embodiment 1 in accordance with the present invention;

FIG. 2 is a diagram for explaining information stored in an input vocabulary storage of the navigation system of the embodiment 1 in accordance with the present invention;

FIG. 3 is an activity chart for explaining the operation of the navigation system of the embodiment 1 in accordance with the present invention;

FIG. 4 is a block diagram showing a configuration of a navigation system of an embodiment 2 in accordance with the present invention;

FIG. 5 is a block diagram showing a configuration of a navigation system of an embodiment 3 in accordance with the present invention;

FIG. 6 is a diagram for explaining a vocabulary hierarchy in the navigation system of the embodiment 3 in accordance with the present invention;

FIG. 7 is a diagram showing an example of a structure of a vocabulary hierarchy table of the navigation system of the embodiment 3 in accordance with the present invention;

FIG. 8 is an activity chart for explaining the operation of the navigation system of the embodiment 3 in accordance with the present invention;

FIG. 9 is a block diagram showing a configuration of a navigation system of an embodiment 4 in accordance with the present invention;

FIG. 10 is a diagram showing an example of a display screen in the navigation system of the embodiment 1 in accordance with the present invention;

FIG. 11 is a diagram for explaining a method of generating preference information from a Web page in the navigation system of the embodiment 2 in accordance with the present invention;

FIG. 12 is a diagram showing an example of an application using the vocabulary hierarchy in the navigation system of the embodiment 3 in accordance with the present invention; and

FIG. 13 is a diagram showing an example of a display screen in the navigation system of the embodiment 4 in accordance with the present invention.

### BEST MODE FOR CARRYING OUT THE INVENTION

The best mode for carrying out the invention will now be described with reference to the accompanying drawings to explain the present invention in more detail.

### Embodiment 1

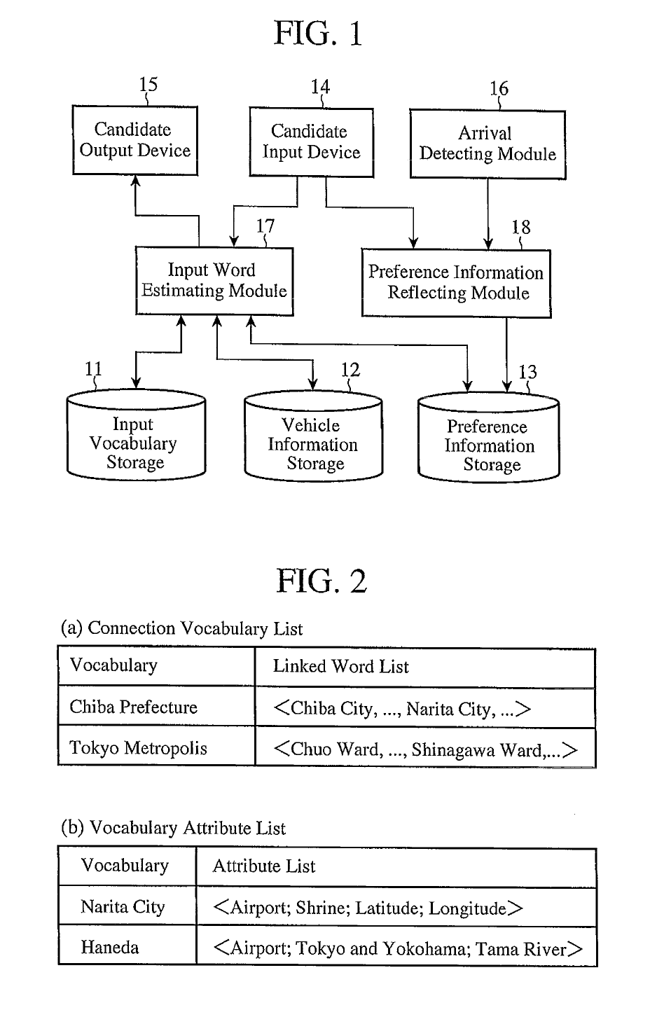

FIG. 1 is a block diagram showing a configuration of a navigation system of an embodiment 1 in accordance with the present invention. The navigation system comprises an input vocabulary storage 11, a vehicle information storage 12, a preference information storage 13, a candidate input device 14, a candidate output device 15, an arrival detecting module 16, an input word estimating module 17 and a preference information reflecting module 18.

The input vocabulary storage 11 stores words to become candidates for search items (targets) such as prefecture names, city names or facility names input from the candidate input device 14 and words associated with them. Details of the information stored in the input vocabulary storage 11 will be described later. The information stored in the input vocabulary storage 11 is read out by the input word estimating module 17. Incidentally, the input vocabulary storage can be constructed on a network.

The vehicle information storage 12 stores information used in navigation functions. For example, it stores information about the vehicle such as vehicle speed, a screen state, prescribed positions like a destination and way points, a vehicle own position, and distance from the vehicle own position to a prescribed position as the vehicle information. The vehicle information stored in the vehicle information storage 12 is read out by the input word estimating module 17.

The preference information storage 13 stores, as to words the user inputs in the past, words corresponding to spots the user has visited in the past, and words relating to them, the information about input or visit as preference information representing users preference. The preference information includes at least the date and time and the number of times the words are selected. Besides the cases where they are selected directly, the preference information is also stored in the cases where they are selected indirectly by the selection of other relating words. The preference information stored in the preference information storage 13 is accessed by the input word estimating module 17 and preference information reflecting module 18. The preference information storage must not be placed within the navigation system, and a configuration is possible in which it is placed on a network.

The candidate input device 14, which comprises a touch panel, a remote control or a microphone for inputting voice, for example, is used for inputting a prescribed position. A search key input from the candidate input device 14 is delivered to the input word estimating module 17 and preference information reflecting module 18.

The candidate output device 15, which comprises a liquid crystal display unit or a speech production unit, outputs an estimated word or words transferred from the input word estimating module 17, or a prescribed position or part of it as a candidate. For example, the liquid crystal display unit serving as the candidate output device 15 displays the estimated vocabulary or its part as a candidate vocabulary list.

The arrival detecting module 16 detects that the vehicle arrives at a prescribed position input from the candidate input device 14. When the arrival detecting module 16 detects the arrival at the prescribed position, it notifies the preference information reflecting module 18 of that.

The input word estimating module 17 searches, when part of a character or word is input from the candidate input device 14, the vocabularies stored in the input vocabulary storage 11, and estimates words obtained by the search according to an order of priority based on the vehicle information stored in the vehicle information storage 12 and based on the vocabulary stored in the preference information storage 13 to generate the candidate vocabulary list. The candidate vocabulary list generated by the input word estimating module 17 is delivered to the candidate output device 15.

The preference information reflecting module 18 records in the preference information storage 13 the word at the time when one word is selected from the candidate vocabulary list supplied to the candidate output device 15, the search key at the time when a new search key is input and added to the search keys that have been input via the candidate input device 14, or the prescribed position at the time when the arrival detecting module 16 notifies that the vehicle arrives at the prescribed position after the prescribed position has been set.

FIG. 2 is a diagram for explaining the information stored in the input vocabulary storage 11. The input vocabulary storage 11 retains at least a connection vocabulary list and a vocabulary attribute list.

The connection vocabulary list stores search keys that can be input and their links. For example, it stores “Chiba City”, “Narita City”, as a vocabulary that can be input after a character string “Chiba Prefecture” is input as a search key. Incidentally, a configuration is also possible which switches connection vocabulary lists for individual applications, or adds or deletes a connection vocabulary list.

The vocabulary attribute list stores, for the purpose of extracting the vocabulary associated with a search key that can be input, associated words and phrases or numerical values. For example, the vocabulary attribute list stores attributes of a city such as an “airport” or the “latitude” and “longitude” representing the land, in connection with the vocabulary associated with a search key that can be input.

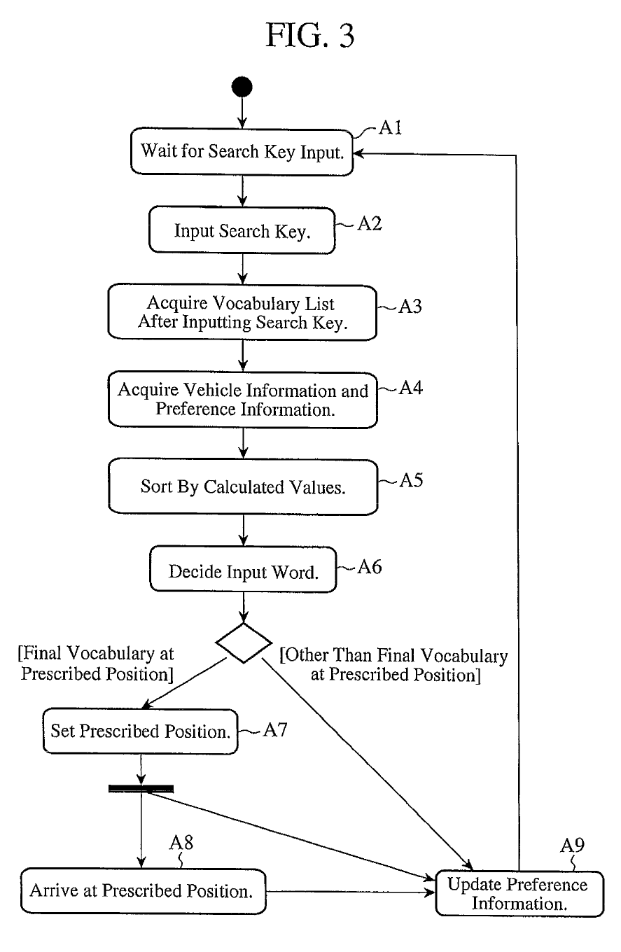

Next, the operation of the navigation system of the embodiment 1 in accordance with the present invention will be described with reference to the activity chart shown in FIG. 3.

Once started, the navigation system enters a search key input waiting mode (A1). In the search key input waiting mode, a search key is input (A2). In other words, the user inputs a word or its part using the candidate input device 14. The word or its part input via the candidate input device 14 is delivered to the input word estimating module 17. Incidentally, besides the character input, voice input and the like, the search key can be an image associated with an input vocabulary.

Subsequently, a vocabulary list is obtained following the input word (A3). More specifically, the input word estimating module 17 obtains, when the word or its part is input via the candidate input device 14, all the words which are likely to follow that from the connection vocabulary list from the input vocabulary storage 11. Subsequently, the vehicle information and preference information are obtained (A4). More specifically, the input word estimating module 17 obtains the vehicle information from the vehicle information storage 12 and the preference information from the preference information storage 13, and carries out value fixing to the words it obtains from the connection vocabulary list (a method of value fixing will be described later).

Subsequently, sorting is carried out according to the values obtained by the calculation (A5). More specifically, the input word estimating module 17 carries out sorting in accordance with the values obtained by the value fixing, generates a candidate vocabulary list by arranging the words passing through the sorting in descending order of values, and delivers it to the candidate output device 15. Subsequently, the input word is decided (AG). More specifically, the user selects one of the words from the vocabulary candidate list output via the candidate output device 15.

Subsequently, if the decided input word is the final word, a prescribed position is set (A7). After that, the vehicle arrives at the prescribed position (A8). The preference information is updated at the point at which the user selects the word, or the point after setting the prescribed position, or when the arrival detecting module 16 detects the arrival at the prescribed position (A9). More specifically, the preference information reflecting module 18 rewrites the preference information storage 13. In this case, it stores at least the time of selection or arrival, and the number of times of the selection or arrival up to that time.

To summarize the foregoing operation, when the word or its part is input, the input word estimating module 17, using at least one of the candidate connection vocabulary list, preference information, and vehicle information, carries out sorting in accordance with an estimation rule retained in the input word estimating module 17 after performing the value fixing of priority to the candidates, and outputs to the candidate output device 15.

In addition, the preference information reflecting module 18 can generate the candidate vocabulary list taking account of the time elapsed from the selection by having recorded the date and time of the word selection in the preference information storage 13 and by applying the estimation rule retained in the input word estimating module 17. Thus, it becomes possible to preferentially display words and phrases selected recently and spots visited recently, or to preferentially display spots which have been visited often previously but not visited recently.

In addition, recording the selection time of the words, the preference information reflecting module 18 can be configured in such a manner as to delete the preference information stored in the preference information storage 13 when a fixed time period has elapsed. The configuration makes it possible to delete old preference information of a person, to decide the priority using only new preference information, and to reduce the amount of the preference information to be retained.

Here, the estimation rule retained in the input word estimating module 17 is defined by the following expression (1), where f is a function having as its input variables “wordlist, a vocabulary having selected already (a list consisting of any desired number of words)”; “next_word, a word to be selected next”; and “paramlist, any desired number of attributes used”.

f(wordlist, next_word, paramlist)→R (1)

Such a function enables the value fixing of the degree of priority such as “setting the degree of priority of the word selected recently at a high level”, and “maintaining the degree of priority of the words that have elapsed a fixed time period”.

Incidentally, when a route to the prescribed position has been decided (when the route search has been performed by the navigation function), search keys used for facilities and addresses near the route surroundings can be used as the input variables. Such a configuration makes it possible to employ the facilities and addresses along the route as preferential candidates.

Some concrete examples of estimation in the navigation system of the present embodiment 1 will be described below.

[1] Concrete Example of Extracting User's Preference from Vocabulary Once Visited.
When the user selects “Narita City in Chiba Prefecture”, the preference information reflecting module 18 records the selection of “Narita City” in the preference information storage 13.
After “Shinagawa Ward, Tokyo” is selected next, the input word estimating module 17 obtains a place-name in Shinagawa Ward as a list of candidates.
Without considering the effect of the other preference information and the like, the degree of priority of “Haneda”, which has the same attribute “airport” as “Narita” selected previously, becomes maximum.

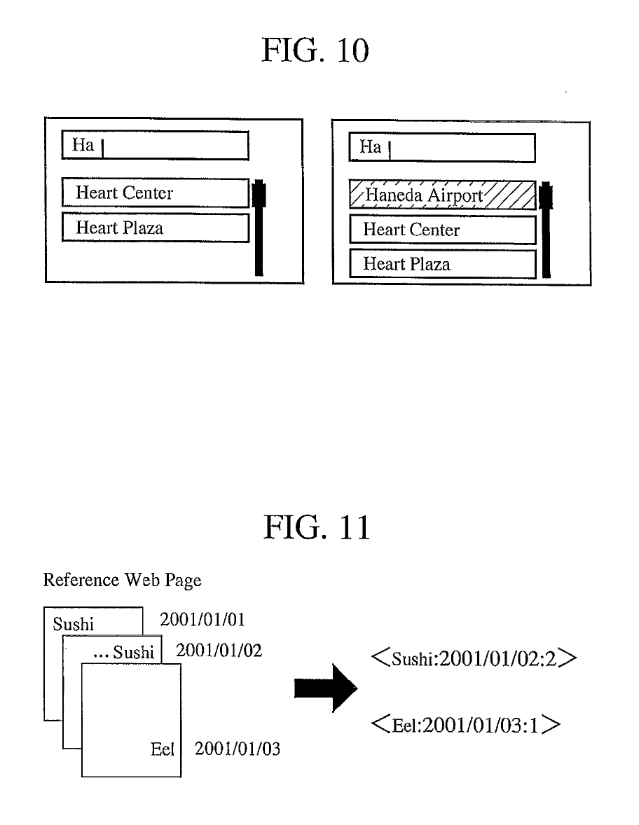

The same method is applicable to the estimation of not only the addresses but also the spots. FIG. 10 shows a display screen example before taking importance into account, and a display screen example after taking importance into account. In the foregoing example of the “airport”, the importance of Haneda Airport is increased for the user who has selected or arrived at “Narita Airport”. More specifically, when the user inputs a first character “ha” on the input screen of a search keyword, its importance is taken into account and “Haneda Airport” is preferentially displayed as an estimated candidate. Furthermore, to distinguish between the normal list and the estimated candidates, such a step can be taken of varying colors of the item within the list.

[2] Concrete Example of Estimating Spot to be Visited from Distance from Spot Once Visited.
When the user selects “Narita City in Chiba Prefecture”, the preference information reflecting module 18 records the selection of “Narita City” in the preference information storage 13.
At the same time, the preference information reflecting module 18 records that regional names in the surroundings of Narita City in Chiba Prefecture are indirectly selected in the preference information storage 13. A vocabulary corresponding to the place-names in the surroundings can be obtained by calculating the distances from the latitude and longitude information connected to the regional names as shown in FIG. 2.
In this case, a configuration is also possible which stores degrees of closeness in the preference information storage 13.

[3] Concrete Example of Using Both Preference Information and Vehicle Information.
After setting a destination, information about the prescribed position and a route thereto is recorded as the vehicle information.
When deciding the degree of priority in the foregoing [1] while the user inputs a spot he or she stops off on the way, weighting is carried out in accordance with the distance or time period to the prescribed position or the distance or time period from the current route, which are obtained from the vehicle information, and candidates are output to the candidate output device 15.

Considering that the preference information can vary from person to person, a system configuration is also possible which prepares the preference information storage for each person after combining with an existing personal identification method, and switches among a plurality of persons. In addition, not only individual persons, but also groups (a plurality of persons each) can share the preference information.

As described above, according to the navigation system of the embodiment 1 in accordance with the present invention, since it preferentially outputs the vocabulary corresponding to user's preference as the candidates when the user inputs a prescribed position, for example, it can reduce a burden of the input operation. In addition, instead of choosing the candidates simply from the vocabulary or spots having been selected previously, or from the spots having been visited, it can choose the candidates from the words and phrases having close relation with the selected spots. Furthermore, it can extract and utilize user's preference.

In addition, using the vehicle information stored in the vehicle information storage 12 makes it possible to utilize user's preference based on the current information. In other words, it becomes possible to utilize user's preference by switching in response to current conditions. As examples of a function used in this case, there are those as “Give priority to those closer to the current position”, “Increase the degree of priority as the time taken to reach becomes shorter” and so on.

Although the example shown here is a destination estimating technique based on the Japanese language, the technique itself does not depend on languages because it estimates the destination according to combinations of the words and attributes shown in FIG. 2, and a mixed mode of multiple languages is also possible.

### Embodiment 2

The navigation system of an embodiment 2 in accordance with the present invention employs external information (referred to as “external preference information” from now on) as the preference information.

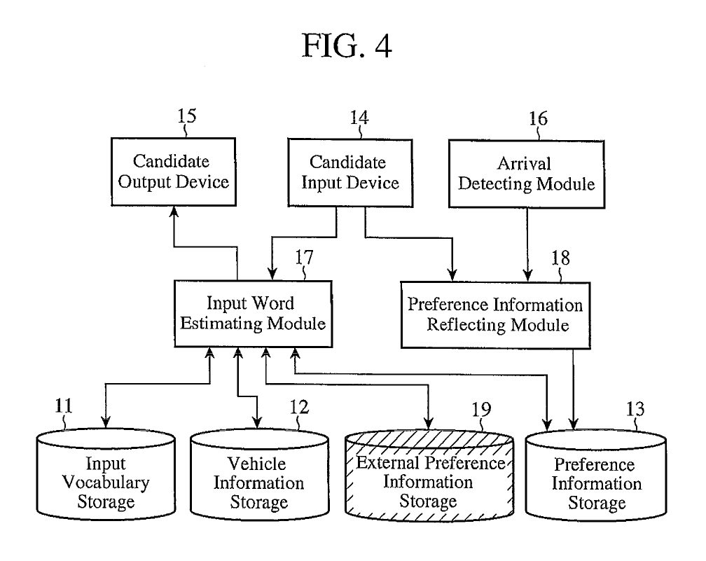

FIG. 4 is a block diagram showing a configuration of the navigation system of the embodiment 2 in accordance with the present invention. The navigation system comprises an external preference information storage 19 in addition to the navigation system of the embodiment 1 shown in FIG. 1.

The external preference information storage 19 stores the external preference information. Here, the term “external preference information” refers to vocabularies used besides the vocabularies stored in the input vocabulary storage 11. For example, it refers to phone numbers recorded in the telephone directory stored in the navigation system; phone numbers recorded in the telephone directory stored in a cellular phone or addresses or facilities recorded in the address book thereof; an input history of words on a user's personal computer, which are stored in an external storage system or obtained via a network; character strings contained in metadata relating to videos recorded at user's own house; and character strings contained in Web pages that are read often.

Since the preference information includes at least the date and time and the number of times of the word selection, information corresponding to the date and time and the number of times of the word selection must be generated by analyzing the character strings in the metadata and Web pages. FIG. 11 is a schematic diagram illustrating a method of generating the preference information from Web pages according to the foregoing method. It can generate the preference information by employing the date and time of generating the metadata or the date and time of referring to Web pages as the date and time of the word selection, and by employing the occurrence frequencies of the words in the metadata or Web pages as the number of times of selection.

As for the external preference information, since the input word estimating module 17 uses it for estimating the input words to the navigation system, the foregoing Expression (1) is adjusted as the following Expression (2).

f(wordlist, next_word, paramlist, outer_info)→R (2)

where outer_info is a vocabulary list and its attributes contained in the external preference information. The vocabulary list and its attributes contained in the external preference information storage 19 have the same styles as the connection vocabulary list and vocabulary attribute list, which are shown in FIG. 2 and used in the navigation system of the embodiment 1, and as those in the preference information storage 13.

As described above, according to the navigation system of the embodiment 2 in accordance with the present invention, it can preferentially display addresses and facility names recorded in the address book when there are a plurality of candidates decided by the preference information.

Incidentally, in Expression (2), although the external preference information has an effect on the estimated value as in the embodiment 1, a configuration is also possible which carries out, instead of using Expression (2) once, the value fixing using Expression (1) followed by applying weighting again to the list obtained as a result of Expression (1). The configuration can sometimes reduce the time period up to the output of the final candidates.

In addition, the input word estimating module 17 can also be configured in such a manner as to perform weighting on the preference information stored in the preference information storage 13, and to decide the degree of priority compositely. According to the configuration, it can vary the information used for deciding the degree of priority in accordance with the preference or condition of the user.

### Embodiment 3

The navigation system of an embodiment 3 in accordance with the present invention estimates the prescribed position using a vocabulary hierarchy.

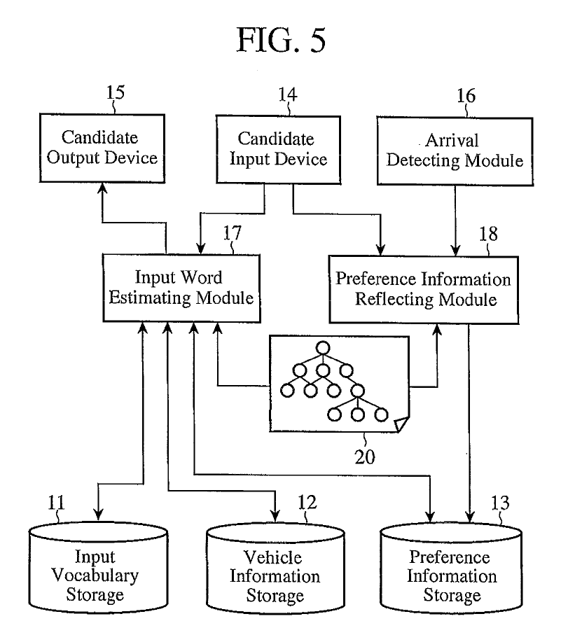

FIG. 5 is a block diagram showing a configuration of the navigation system of the embodiment 3 in accordance with the present invention. The navigation system comprises a vocabulary hierarchy table 20 in addition to the navigation system of the embodiment 1 shown in FIG. 1.

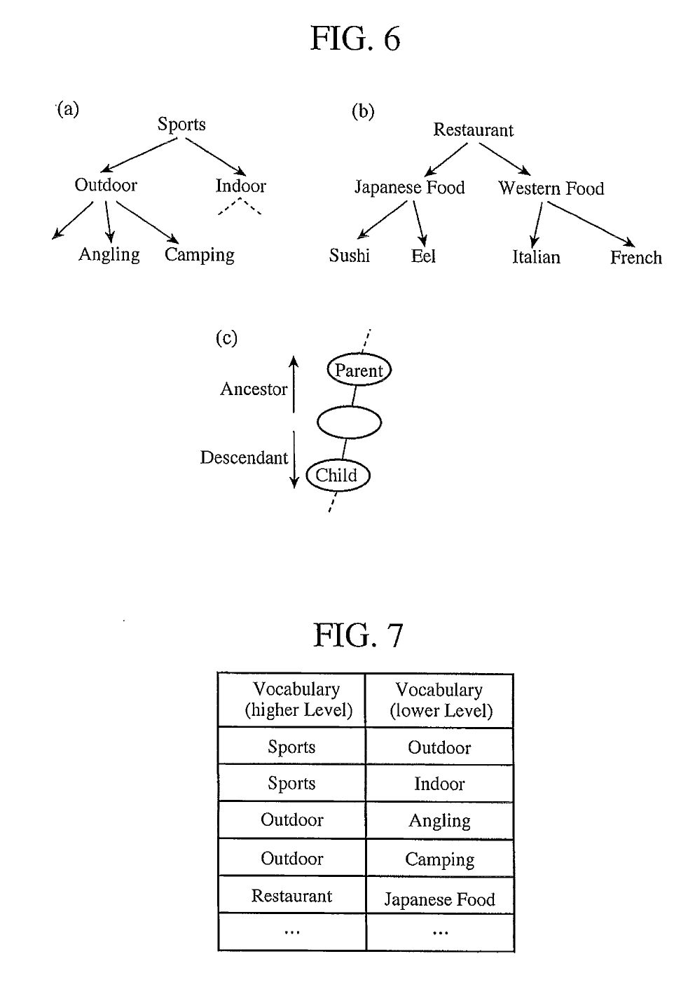

The vocabulary hierarchy table 20 stores words hierarchically in accordance with the meaning as shown in FIG. 6(a) and FIG. 6(b), for example. To be more concrete, the vocabulary hierarchy table 20 is formed in a format as shown in FIG. 7. The preference information reflecting module 18 can extract, when updating the preference information by extracting the attributes of related words, a wider range of preferences using the hierarchy of the words determined in advance by the vocabulary hierarchy table 20.

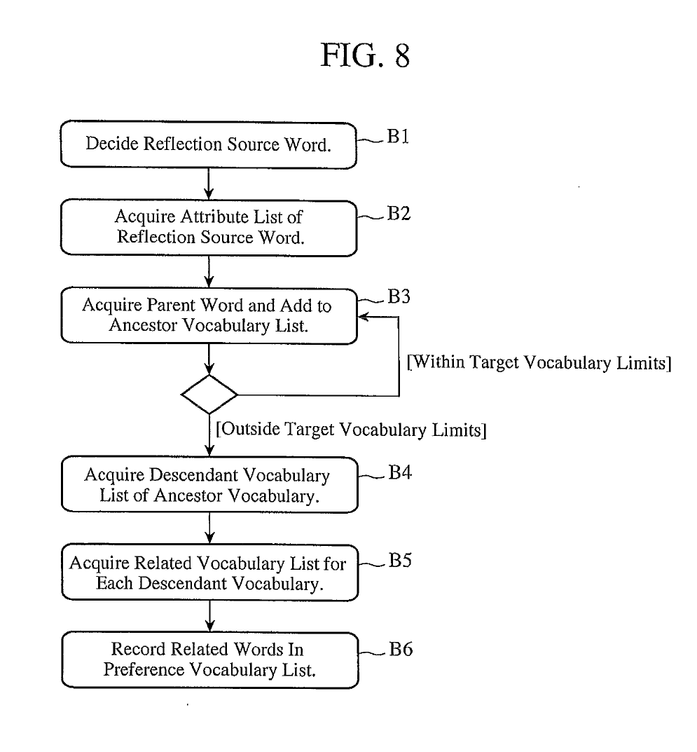

FIG. 8 is an activity chart showing a method of extracting the preference having the vocabulary hierarchy as shown in FIG. 6 and FIG. 7. First, a reflection source word is determined (B1). Here, the term “reflection source word” refers to a word selected by the user, or a word or a word set (prefecture name, city name and so on) designating a prescribed position at the time of detecting the arrival at the prescribed position.

Subsequently, the attribute list of the reflection source word is obtained (B2). Then, a parent word is obtained and is added to an ancestor vocabulary list (B3). Here, the term “parent word” refers to a word indicating a superordinate concept of a particular word as shown in FIG. 6(c), and a term “child word” refers to a word indicating a subordinate concept of a particular word. In addition, the term “ancestor vocabulary” refers to a vocabulary obtained by going back to parent words such as a parent word of a parent word, and further a parent word thereof (FIG. 6(c)). For example, let us consider centering on “outdoor” shown in FIG. 6(a). In this case, the parent word corresponds to “sports”, and the subordinate word to “angling”. Then, within limits of a target vocabulary, the processing of acquiring a parent word and of adding to the ancestor vocabulary list is repeated. Here, the term “within limits of a target vocabulary” refers to the predetermined number of levels of the parent words. Thus, as the number of the parent words to be traced increases, a range of obtaining the related words becomes wider.

Outside the limits of the target vocabulary, a descendant vocabulary list of the ancestor vocabulary is obtained (B4). Here, the term “descendant vocabulary list” refers to a list whose elements consist of all the child words within the limits of the target vocabulary range. Subsequently, a related vocabulary list for each descendant vocabulary is obtained (B5). Here, the term “related vocabulary” refers to a vocabulary recorded in the preference vocabulary list from the descendant vocabulary list. A decision as to whether to be recorded in the preference vocabulary list or not is made by the input word estimating module 17.

When a vocabulary hierarchy as shown in FIG. 7 is retained, all the ancestor vocabulary lists are obtained by extracting words appearing above all the records, in the subordinate levels of which the corresponding word appears, by extracting the records, in the subordinate levels of which the words extracted appear, and by repeating them until the limits of the range is exceeded, and then all the subordinate words of the ancestor vocabulary list are obtained.

Incidentally, since the vocabulary hierarchy has a general tree structure, a search method of the tree structure is applicable to obtaining the related vocabulary.

As described above, according to the navigation system of the embodiment 3 in accordance with the present invention, when extracting the preference, it can not only decide that the vocabulary that has been once selected or set has a stronger preference, but also decide that the vocabulary similar in meaning has a higher preference level.

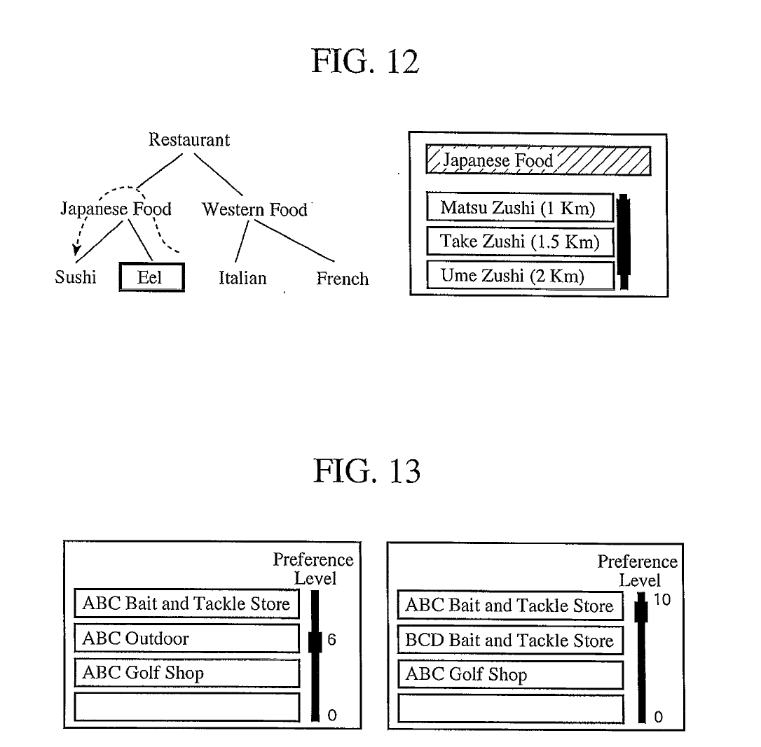

In addition, besides the object estimate, the technique is also applicable to show an alternative plan when lacking information the user desires or lacking enough information items on the display screen. FIG. 12 shows a screen displaying a data processing method and an alternative plan when although a “nearby eel restaurant” is searched for, no target data is found. In this case, since no information corresponding to an “eel” is found, an alternative plan is generated for “Japanese food”, which is one level higher in abstraction.

Furthermore, if the preference level of the alternative plan obtained by the foregoing technique is not high enough, information having a higher preference level can be used as an alternative plan.

### Embodiment 4

The navigation system of an embodiment 4 in accordance with the present invention is configured in such a manner as to estimate the preference level of words.

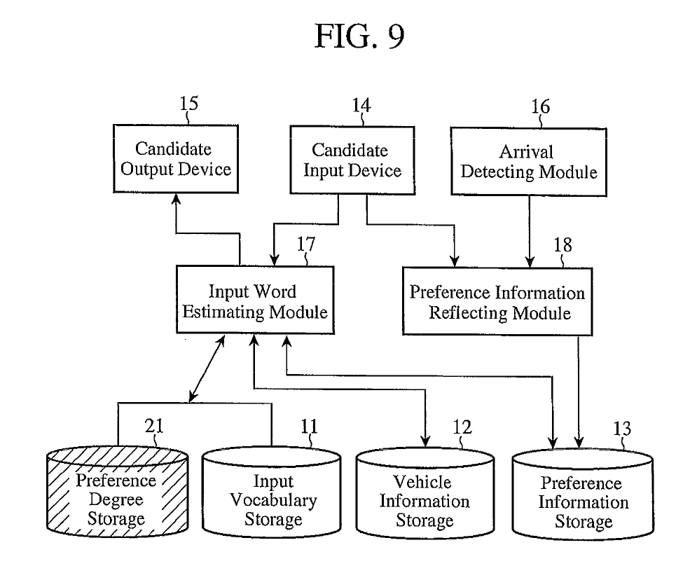

FIG. 9 is a block diagram showing a configuration of the navigation system of the embodiment 4 in accordance with the present invention. The navigation system is constructed by adding a preference degree storage 21 to the navigation system of the embodiment 1 shown in FIG. 1.

The preference degree storage 21 stores information having the preference level added to each input word in a list structure consisting of combinations of <word, preference level>. The input word estimating module 17 estimates the input word using an estimation rule considering the preference level read out of the preference degree storage 21. In addition, making an estimate together with the vehicle information read out of the vehicle information storage 12 enables an assignment of the degree of priority such as giving priority to a word with a lower preference level during low speed running.

Incidentally, the order of priority used at the estimation obtained from the preference degree information, vehicle information and preference information can be used not only for the estimation of input characters, but also for the assignment of the order of priority when displaying candidates at a time of the keyword search performed as one of the navigation functions. The configuration can reduce the input burden at the time of keyword search.

Furthermore, the input word estimating module 17 can be configured in such a manner as to vary weighting of the preference level to the words in accordance with the vehicle information stored in the vehicle information storage 12 or with the output conditions to the candidate output device 15. According to the configuration, priority display in accordance with the running state becomes possible. For example, it can place priority on displaying keywords with lower degrees of preference during the low speed running near the destination, or when the reduction of a map displayed for navigation is small.

FIG. 13 shows a screen for the user to explicitly provide the preference level to limit the candidates when the number of search items of the candidates is too large. Here, if “angling” or “golf” is given a higher preference level than “outdoor”, and when the user changes the preference level displayed on the screen from 6 to 10, outdoor search items are deleted from the candidate search items. As a situation in which such a list useful, a surrounding search or a display of recommended spots is conceivable. Incidentally, the vocabulary hierarchy as shown in FIG. 6 can be used as the preference level.

As described above, according to the navigation system of the embodiment 4 in accordance with the present invention, it can distinguish between the vocabulary with a strong preference level (vocabulary which differs greatly in the frequency of use from person to person) and the vocabulary with a weak preference level (vocabulary which is used widely and generally) in terms of numerical values or symbols. Thus, it can limit the candidates to be displayed or perform priority display in response to a user setting.

### INDUSTRIAL APPLICABILITY

As described above, the navigation system in accordance with the present invention is configured in such a manner as to reduce troublesomeness of inputting a destination by searching for the vocabulary corresponding to an input keyword and by outputting the vocabulary in accordance with the order of priority based on the vehicle information and preference information. Accordingly, it is suitably applied to on-board navigation systems and the like.

What is claimed is:

1. A navigation system comprising:
a candidate input device for inputting a search key;
an input vocabulary storage that stores words to become candidates of a search item input from the candidate input device;
a vehicle condition storage for storing vehicle information relating to a vehicle;
a preference information storage for storing preference information representing user's preference in connection with the words stored in the input vocabulary storage;
an input word estimating module for searching the input vocabulary storage for words corresponding to the search key input from the candidate input device, and for estimating the words obtained by the search in accordance with an order of priority based on the vehicle information readout of the vehicle condition storage and the preference information read out of the preference information storage; and
a candidate output device for outputting the words delivered from the input word estimating module as candidates.

2. The navigation system according to claim 1, further comprising:
an arrival detecting module for detecting arrival at a prescribed position; and
a preference information reflecting module for searching the input vocabulary storage for the prescribed position when the arrival detecting module detects the arrival at the prescribed position, for the word when a word input from the candidate input device is decided, or for a word associated with the prescribed position when the prescribed position output to the candidate output device is selected, and for storing in the preference information storage as preference information after adding a degree of priority indicating a degree of association with the word searched.

3. The navigation system according to claim 2, wherein
the preference information reflecting module adds, to the searched word, time at which selection of the word or arrival at the prescribed position occurs, and stores in the preference information storage as the preference information; and
the input word estimating module calculates time elapsed from the time contained in the preference information stored in the preference information storage, and decides an order of priority using a function that uses the calculated time elapsed as an input variable and outputs the degree of priority.

4. The navigation system according to claim 3, wherein
the preference information reflecting module deletes the preference information stored in the preference information storage when a fixed time period has elapsed.

5. The navigation system according to claim 2, wherein
the input word estimating module decides an order of priority using a function that employs the preference information stored in the preference information storage and the vehicle information obtained from vehicle information storage as input variables, and that outputs the degree of priority.

6. The navigation system according to claim 2, further comprising:
an external preference information storage for storing external information as external preference information; wherein
the input word estimating module decides an order of priority using a function that employs the preference information stored in the preference information storage and the external preference information obtained from the external preference information storage as input variables, and that outputs the degree of priority.

7. The navigation system according to claim 2, wherein
the input word estimating module obtains facility names and addresses along a route to the prescribed position, and outputs words estimated in accordance with an order of priority which is decided by a function that employs the preference information stored in the preference information storage and the external preference information obtained from the external preference information storage as input variables, and that outputs the degree of priority.

8. The navigation system according to claim 2, further comprising:
a vocabulary hierarchy table that stores words hierarchically in accordance with meaning, wherein
the preference information reflecting module searches, using the vocabulary hierarchy table, for a word similar in meaning to a word set at the prescribed position or to a selected word, and records the degree of association as to the word searched.

9. The navigation system according to claim 2, wherein
the input word estimating module assigns weights to the preference information stored in the preference information storage to decide the degree of priority compositely.

10. The navigation system according to claim 1, further comprising:
a preference degree storage for storing information representing a preference level of each person in correspondence with the words stored in the input vocabulary storage, wherein
the input word estimating module estimates the input word by acquiring words corresponding to the preference level stored in the preference degree storage.

11. The navigation system according to claim 10, using words, to which the preference level is assigned, for assigning an order of priority when displaying candidates at a time of carrying out a keyword search as one of navigation functions.

12. The navigation system according to claim 10, wherein
the input word estimating module varies weighting of the preference level to the word in accordance with the vehicle information stored in the vehicle information storage or with output conditions to the candidate output device.
